(19) United States
(12) Patent Application Publication
(10) Pub. No.: US 2016/0080970 A1
(43) Pub. Date: Mar. 17, 2016

(54) Virtual International Mobile Subscriber Identity Based Insight Delivery To Mobile Devices

(71) Applicant: NOKIA SOLUTIONS AND NETWORKS OY, Espoo (FI)

(72) Inventors: John HARRIS, Glenview, IL (US); Sean KELLEY, Hoffman Estates, IL (US); Tero HENTTONEN, Espoo (FI)

(21) Appl. No.: 14/819,076

(22) Filed: Aug. 5, 2015

Related U.S. Application Data
(63) Continuation-in-part of application No. PCT/US2015/041073, filed on Jul. 20, 2015.
Application No. PCT/US2015/041073 is a continuation-in-part of application No. PCT/EP2014/069585, filed on Sep. 15, 2014.
(60) Provisional application No. 62/175,676, filed on Jun. 15, 2015.

(51) Int. Cl. H04W 28/02; H04W 8/08; H04W 68/00

(52) U.S. Cl. CPC H04W 28/0284; H04W 68/00; H04W 8/082

(57) ABSTRACT

Network insights may be useful in various communication networks. For example, certain cellular or similar networks may benefit from the delivery of cellular network insights to subscriber devices based on virtual international mobile subscriber identity (IMSI). For example, a method can include detecting, by a device, at least one paging message over a cellular system. The method can also include extracting, from the at least one paging message, at least one cellular network insight including at least one cellular network condition. The paging message may include a virtual IMSI.

### CROSS REFERENCE TO RELATED APPLICATIONS

This application is a continuation-in-part of and claims the benefit and priority of PCT/US2015/041073, filed Jul. 20, 2015, the entirety of which is hereby incorporated herein by reference. This application is also a continuation-in-part of and claims the benefit and priority of Patent Cooperation Treaty (PCT) Patent Application No. PCT/EP2014/069585, filed Sep. 15, 2014, which is hereby incorporated herein by reference in its entirety. This application is additionally related to and claims the benefit and priority of U.S. Provisional Patent Application No. 62/175,676 filed Jun. 15, 2015, which is hereby incorporated herein by reference in its entirety.

### BACKGROUND

1. Field

Network insights may be useful in various communication networks. For example, certain cellular or similar networks may benefit from the delivery of cellular network insights to subscriber devices based on virtual international mobile subscriber identity.

2. Description of the Related Art

The use of mobile wireless devices for sending and/or receiving data is increasing. At the same time, the delivery of video data is consuming a larger and larger share of available wireless capacity, both because of the popularity of video and because video applications inherently consume relatively great amounts of data.

Various techniques such as media optimization and adaptive streaming servers promise to significantly increase system capacity and video quality in wireless networks such as third generation partnership project (3GPP) long term evolution (LTE) networks. For example, media optimizer and adaptive streaming servers can manage downloading of video to user equipment, such as a camera phone, smart phone, tablet computer, media play with wireless capability, or the like, just in time to be played. Such an approach may avoid waste of resources when a user abandons a video before the video is complete, because the approach can avoid transferring data that will never be used.

A user may frequently experience a gap in coverage or impaired coverage, so that under some circumstances video will be not be available at the moment it is needed. Delivering data before it is needed, which may be referred to as pre-filling data, can avoid interruption or degradation of video quality. This discussion will be presented primarily in terms of video data, but the mechanisms described here may be applied to any circumstances in which data is delivered as needed in order to use transmission capacity efficiently, but in which conditions are evaluated to determine whether data should be delivered before it is immediately needed.

The need for pre-filling of data can vary based on the particular circumstances of a user equipment (UE). In addition, turning to the example of video data, much video data can be configured so as to be playable only by a single UE, as in the case in which video is encrypted with a key provided only to a single UE or a few UEs, or in the case in which digital rights management (DRM) is used, so that video is configured to be transferable only to a single UE.

If video data is to be reliably delivered, however, accommodations may need to be made for areas experiencing poor coverage or significant loads, interfering with the ability of a UE to receive data just in time for playback. Under such circumstances, the UE may benefit from receiving data during times when it may be efficiently delivered, so that the data can be available for playback during a period of slow or no delivery. The control if video transfers can be related to network knowledge sharing, or the sharing of network analytic insights.

Data analytics insights are transforming various industries by linking these insights with decisions. Network infrastructure can generate network insights, for example, from the evolved node B (eNB), Radio Applications Cloud Server (RACS) and customer experience manager (CEM). These types of insights can be useful to many devices or elements of the network. For instance, this type of information can be useful to mobile applications also known as apps. An app may be considered to be a self-contained program or piece of software designed to fulfill a particular purpose, for example as downloaded by a user to a mobile device. Apps on mobile devices (e.g., smartphones, tablets, other portable computing devices, etc.) may make many decisions, using nuanced and rapidly changing app knowledge.

### SUMMARY

According to certain embodiments, a method can include detecting, by a device, at least one paging message over a cellular system. The method can also include extracting, from the at least one paging message, at least one cellular network insight including at least one cellular network condition.

In certain embodiments, a method can include detecting, at a device, a first level of network congestion on a cellular network. The method can also include, in response to the detecting of the first level of network congestion, transmitting a paging message. The paging message can include an international mobile subscriber identity (IMSI) value over the cellular network. The IMSI value can encode the first level of network congestion on the cellular network.

An apparatus, according to certain embodiments, can include at least one processor and at least one memory including computer program code. The at least one memory and the computer program code can be configured to, with the at least one processor, cause the apparatus at least to detect, by a device, at least one paging message over a cellular system. The at least one memory and the computer program code can also be configured to, with the at least one processor, cause the apparatus at least to extract, from the at least one paging message, at least one cellular network insight including at least one cellular network condition.

An apparatus, in certain embodiments, can include at least one processor and at least one memory including computer program code. The at least one memory and the computer program code can be configured to, with the at least one processor, cause the apparatus at least to detect, at a device, a first level of network congestion on a cellular network. The at least one memory and the computer program code can also be configured to, with the at least one processor, cause the apparatus at least to, in response to the detection of the first level of network congestion, transmit a paging message. The paging message can include an IMSI value and can be transmitted over the cellular network. The IMSI value can encode the first level of network congestion on the cellular network.

According to certain embodiments, an apparatus can include means for detecting, by a device, at least one paging message over a cellular system. The apparatus can also include means for extracting, from the at least one paging message, at least one cellular network insight including at least one cellular network condition.

In certain embodiments, an apparatus can include means for detecting, at a device, a first level of network congestion on a cellular network. The apparatus can also include means for, in response to the detecting of the first level of network congestion, transmitting a paging message. The paging message can include an international mobile subscriber identity (IMSI) value over the cellular network. The IMSI value can encode the first level of network congestion on the cellular network.

A computer program product can, in certain embodiments, be encoded with instructions for performing any of the above-described methods.

A non-transitory computer-readable medium can, according to certain embodiments, be encoded with instructions that, when executed in hardware, perform any of the above-described methods.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

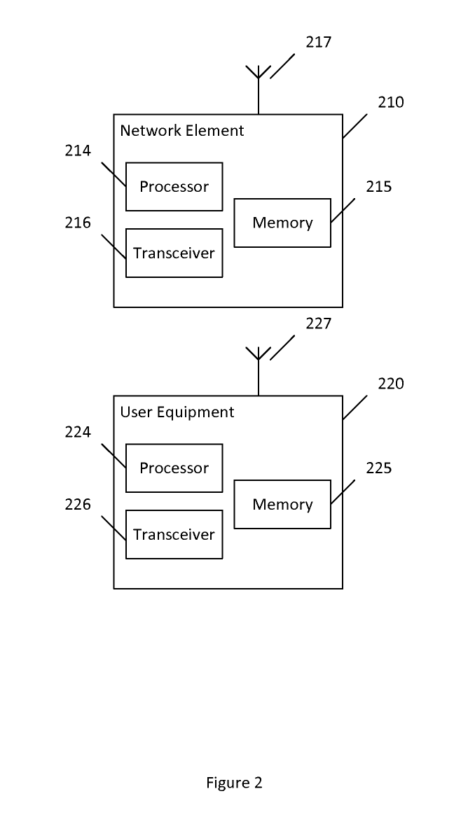

### DETAILED DESCRIPTION

Certain embodiments provide a mechanism to enable identifying that subscribers are going to perform a proprietary knowledge sharing protocol between the subscriber device and the network. This knowledge sharing protocol may govern sharing congestion information down to the user equipment (UE), and obtaining advanced knowledge of anticipated user traffic activity up from the UE.

More particularly, certain embodiments provide for utilizing one or more reserved international mobile subscriber identity (IMSI) values within paging messages in order to convey specific network assistance data to UEs. One such reserved IMSI may indicate that that particular cell is particularly congested. Another such IMSI may indicate that that particular cell is relatively un-congested. Both of these IMSI may convey that the network supports a specific proprietary protocol. For example, these IMSI may convey that the UE can transmit specific proprietary medium access control (MAC) and/or radio resource control (RRC) messages on the uplink to the eNB. The eNB can then use proprietary mechanisms to determine when and if any of the above special reserved IMSI values should be transmitted. This determination can permit the eNB to avoid transmitting these IMSI page indicators, except where the benefit to the overall eNB congestion, for example from reduced background UE traffic, is predicted to outweigh the cost of transmitting the single additional page. Certain embodiments may be further efficient in that many UEs normally wake up in order to check to see if they are receiving a page. In this discussion, an eNB is provided as one example of an access node. Other kinds of access nodes, such as other kinds of base stations or access points are also permitted.

By tunneling such network assistance data over long term evolution (LTE), certain embodiments can convey that the network assistance data is available over the entire cellular coverage area. In contrast, with the use of proprietary signaling over RRC or MAC, the delivery may be repetitively delivered to many different UEs throughout the cell over unicast signaling. In addition, the approach using tunneling over LTE may also work for idle UEs, in contrast to RRC/MAC approaches that may not work in such cases.

Certain embodiments may be configured to avoid inefficiencies by sharing knowledge/preferences between UE/Apps and eNB. Inefficiencies can include eNB inactivity. Thus, in certain embodiments C-DRX decisions can use knowledge of UE traffic preferences. Similarly, UE decisions can use eNB knowledge of congestion.

This sharing of information may enable a host of things including, for example, improving battery life and capacity, avoiding excess UE connected/modem-on time and excess RRC transitions, and creating numerous additional improvements from joint decision-making.

Certain embodiments may define a protocol for this knowledge sharing. This protocol may relate to radio level messaging, avoiding conflicts with current and future LTE standards releases.

Certain embodiments may use the cn-Domain as a mechanism to provide network insights. This mechanism may be used alone or in combination with the other described embodiments. The cn-Domain can be indicated with the reserved IMSI value within the Page Message. In this way, with a single reserved IMSI value, one bit of network assistance data can be conveyed by controlling the determination as to whether the cn-Domain is set to be PS or CS, e.g. where PS indicates that the network is relatively congested, and CS indicates that it is relatively uncongested.

Certain embodiments may use S-TMSI as a mechanism to provide network insights. This mechanism may be used alone or in combination with the other described embodiments.

Certain embodiments can use the order in which the SIB1 systemInfoValueTag value is rotated. For example, certain embodiments can utilize systemInfoValueTag value to convey protocol support. More particularly, certain embodiments can employ a preagreed specific nonrepeating, nonsequential sequence of the numbers from 0 to 31, including exactly one of each of the numbers. For example, the sequence could begin 22, 31, 3, 16, 6, 29, 15, 2, 21, 24, 9, 20, 30, 1, 19, 23, 8, 26, 25, 27, 17, 14, 13, 18, 4, 28, 0, 10, 5, 7, 11, 12 . . . . When one or more UE detects that the value tag is rotating according to the signature, then the UE can conclude that the proprietary protocol is relatively likely in use. The chance of such a sequence being randomly selected may be very small. The sequence may be scrambled using information known by both the UE and the eNB such as the cell ID. In another example, the sequence utilized may change from a first sequence to a second sequence in order to convey a single bit of network assistance data. However, when this sequence changes from a first sequence to a second sequence, the starting point within the second sequence may be selected such that a threshold number of sequence values will be conveyed (and/or time will elapse) prior to repeating any values recently advertised with the first sequence. In addition, the selection of the second sequence may depend upon the frequency with which the systemInfoValueTag is changing. If the systemInfoValueTag value is changing frequently, then it becomes more important to have a nonrepeating sequence. However, if the systemInfoValueTag is changing relatively infrequently, then it may be more permissible to, for example, have the tag value repeat the same value after 16 value changes, instead of waiting all other 31 values have been used. This is because in the case of a frequently changing systemInfoValueTag, when the system repeats the same value may, this may result in a UE with intermittent coverage seeing that repeated value and then incorrectly determining that no change in the overhead information has occurred.

Static UEs and/or over the top (OTT) signaling between UEs and vendor servers may further enable gathering information on the rotational sequence used by the value tag. The rotational sequence may typically changes infrequently, for example once per hour.

This signature can then convey basic knowledge sharing protocol support. For example, if consecutive values change according to some specific non-repeating pattern then this can indicate protocol support.

Dynamic congestion information can then be further carried within some other secondary knowledge sharing field. For example, the secondary knowledge sharing field can be provided in a page message as discussed above, in spare master information block (MIB) bits as discussed below, system information padding bits, or the like.

MIB can be used while avoiding conflict with LTE standards, for example, by using MIB spare bits. It is possible that LTE may later define use for spares.

Nevertheless, device vendors may implement, within their handsets, an auto network knowledge disable timeout functionality wherein the device can stop extracting network knowledge from the spare bits if more than a threshold number of months have elapsed subsequent to the UE's last software update.

Similarly, eNB software may implement a timer, such that after a threshold number of months after the latest software update, the eNB will stop utilizing network knowledge over the spare bits.

There can be various ways of encoding the insight information. For example, certain embodiments can use the order in which the page addresses are conveyed within a paging message in order to indicate a cellular networking insight to the UE.

In a further embodiment, the network assistance data may be conveyed over SystemInformationBlockType8 (SIB8). In this case the UE may obtain network assistance data based on the use of a (virtual) SID/NID being broadcast over LTE SIB8. The selected SID/NID pair will use a reserved value, that avoids conflicts with existing standard/UEs. This reserved SID (and NID) value would be one that is not used by any CDMA network, so the UE will not have that SID-NID configured as one which it supports for CDMA2000 interworking. Examples of unreserved may include 0, 101, 102, 108, 109, 115, 121, 128, 132, 135, 140, 141, 174, 176. SID values in use may be allocated/controlled by a national authority and may be further observed at http://www.ifast.org/files/NationalSID.htm. In this embodiment, it is then further possible to convey additional network assistance data in the fields within SIB8 including at least one of parametersHRPD, csfb-RegistrationParam1XRTT, longCodeState1XRTT, cellReselectionParameters1XRTT, Sid, nid, multipleSID, multipleNID, homeReg, foreignSIDReg, foreignNIDReg, parameterReg, powerUpReg, registrationPeriod, registrationZone, totalZone, and zoneTimer.

In another embodiment, the network assistance data may be conveyed through the home eNB name indicated through system information block type 9. In a further embodiment, this may utilize invalid UTF-8 codes to indicate the home eNB name, in order to cause standard UEs to ignore and not utilize the home eNB name.

In another embodiment, the network assistance data may be conveyed through additional dummy system information block(s), such as system information block 34. This can be done by adding additional values to the SIB-TYPE list within SIB2. This further enables avoiding conflicting with the LTE standard even as additional SIB types are added, while avoiding the need to add yet additional bit to SIB-TYPE, which would be required if the SIB number were incremented beyond 34, where 34 corresponds to 32 values beyond SIB2.

In another embodiment, the network assistance data may be further conveyed through system information block type 1 wherein the CSG-indication has a Boolean value of false, but the value in the CSG-identity conveys specific network assistance data. In this embodiment this may convey that the cell is a hybrid cell, wherein the CSG identity indicated may be an empty CSG group, where the CSG-identity or group name is used to (further) convey the network assistance data.

For example, within a page message, which can also be referred to as a paging message, the list of the mobile identifiers being paged may be in ascending order, for example using artificially simple short UE identifier numbers 13, 286, 932, and so on. In another example, the list may be in descending order, for example using artificially simple short UE identifier numbers, such as 932, 286, 13.

In a further example, some other order could be used. Whatever ordering rule is selected can be shared between the eNB and the cooperating or aware UEs.

If there are n addresses, then there are n! different possible orderings, where: n!=n*(n−1)*(n−2)* . . . *1, namely n factorial. In other words, there can be n choices for the 1st address, n−1 choices for the 2nd address, and so on.

Certain embodiments may involve the eNB updating the paging message. Such updating can be initiated by the mobility management entity (MME).

Such embodiments may rely on there being a plurality of pages. In the case of only a single page, there is no order information provided. In this case, the network assistance data may be conveyed by then selectively including a reserved IMSI value as discussed. In other words, when there are a larger number of UEs being paged, the order of the pages (e.g. ascending versus descending) may convey the network assistance data. In contrast, when there are fewer UEs being paged, one or more IMSI values may be used to convey the network assistance data.

Certain embodiments can create a pattern in the number of additional octets of padding after the end of the system information message. For example, at the end of each system information message there can be a specific number of octets of bytes of padding. Certain embodiments can utilize these octets of padding, by including network assistance data within those padding fields.

Alternatively, or in addition, certain embodiments can control the number of bytes of padding, including any required impacts on the associated transport block size. Thus, the sequence of the number of padding bytes can convey a unique signature to the UE.

For example, if the number of octets of padding is one, three, three, two in repeating fashion, then the UE may conclude that it is relatively likely that the network is conveying a specific piece of network assistance data to it, which can correspond to that particular pattern. For example, if the number of octets of padding is 1, 3, 4, 2, 5, then the UE may be increasingly confident that the network is uncongested. For example, if the number of octets of padding is 5, 2, 4, 3, 1, then the UE may be increasingly confident that the network is congested. In another example, then the pattern may be of “long” vs. “short” padding, where long means greater than a threshold.

By tunneling such information over LTE, certain embodiments can convey that the network assistance data is available over the entire cellular coverage area. In contrast, with the use of proprietary signaling over RRC or MAC, the delivery may be repetitively delivered to many different UEs throughout the cell over unicast signaling. In addition, various embodiments described above can work not only for connected UEs but also for idle UEs.

In addition to the above, there can be additional downlink payload and/or knowledge sharing attributes. The downlink knowledge sharing messaging can convey one or more specific information elements. These information elements can include one or more of: a short-term or long-term congestion, on one or more of the uplink and the downlink; a short-term or long-term congestion across both up and downlink, which could be a unitless number between one and 8 indicating the congestion state associated with whichever of the two link directions is more congested (this congestion estimate could correspond to a planned bidirectional transfer); an indication of the congestion over alternative wireless technologies, such as Wi-Fi; or an indication of the timescale or cells associated with the congestion estimate provided, for example indicating the timescale associated with the long-term congestion estimate provided over the knowledge sharing protocol.

These information elements can include an indication of a mobility congestion estimate, for example indicating that this is the likely congestion the UE will encounter if the UE is mobile, based on one or more neighbor/likely handoff cells, as opposed to a congestion estimate which is to be expected by the UE if the UE remains relatively static/in that location.

These information elements can include an indication of a recommended time for a transfer, for example within a specific time window indicated by the UE.

These information elements can include an indication of the transfer direction associated with the recommended time for the transfer. Furthermore, these information elements can include an indication of a recommended transfer size, in bytes and/or seconds, associated with the recommended time for the transfer. For example, this could apply in the case where the UE has requested/indicated it plans a particularly large transfer, but the network has identified a smaller uncongested opportunity and has recommended that the UE perform a fraction of the planned transfer during this opportunistic interval.

These information elements can include one or more of the following: an indication that the recommended time for a transfer corresponds to the anticipated transfer indicated by the UE in the uplink knowledge sharing protocol; an indication of the congestion in the cell resulting from a particular category of UEs, for example an indication of the congestion in the cell resulting from UEs from a particular UE provider or vendor, or corresponding to subscribers which support the knowledge sharing protocol; or an indication of congestion in one or more other cells, for example neighboring cells, or an explicit indication of the congestion in an overlay macro cell, which may be relevant for example when a UE is under a small cell, which is in the middle of the coverage area of the macrocell, and the UE has some mobility.

These information elements can include an indication of subscriber experience, for example quality of experience (QoE), corresponding to the experience of the lowest quality subscriber experience in that cell, wherein that subscriber is from a particular category of subscribers. For example, the QoE may be the lowest from a particular UE provider or vendor, or among the UEs using the knowledge sharing protocol in that cell or geographic region.

These information elements can include an indication of the likely sensitivity of the subscriber throughput to the signal strength at the UE. For example, this indication can provide a parameter to the UE which enables the UE to estimate the multiplicative change in the likely throughput achieved as the signal strength (RSRP or RSRQ) changes as the UE moves within that cell, while the cell has a constant level of congestion. In other words the subscriber can use this parameter within a predetermined function to estimate the degree to which changes in signal strength will correlate with faster or slower transfer opportunities.

These information elements can include any of the following: an indication of the RRC inactivity timer value currently planned to be used by the network/eNB for that UE; an indication of the eNB vendor type an/or knowledge sharing protocol version; or an indication that the UE should wait in idle mode until it enters another cell, at which point it should connect in order to determine the current congestion over the knowledge sharing protocol. The indication to wait in idle mode may further indicate specific neighboring cells, for example cells that are lower congestion, where the UE may use this approach

These information elements can include an indication of the type of neighboring cells where the subscriber should subsequently attempt to connect to determine the congestion level. For example, the indication may indicate that the subscriber should connect in order to determine the congestion level over the knowledge sharing protocol only within cells with particular configurations, or cells of particular types, for example small cells, femto cells, or macro cells.

These information elements can include an indication that specific neighboring cells support the knowledge sharing protocol, e.g. using specific references such as cell names or associated cell broadcast information which will enable the UE to later identify that the UE is near such specific cells.

These information elements can include an indication that the knowledge sharing protocol support at that cell is ending shortly. For example, the indication may indicate the time interval after which the protocol support information should be deleted from the UE and/or the UE operating system/ecosystem.

These information elements can include the following: an indication to the UE indicating how to estimate the downlink cell congestion from RSRQ, for example compensating for the level of other cell interference also being received in that approximate location; or an indication to the UE indicating how to estimate the uplink cell congestion from the modulation coding sequence (MCS) assigned as a part of uplink grant(s).

These information elements can include an indication of the degree to which the UE can generate knowledge sharing protocol messaging over the uplink. For example, this indication may prohibit the UEs from transmitting long uplink knowledge sharing messaging in the case where the uplink is congested. This configuration may further be implicit such that the UE automatically determines that it is disallowed from transmitting one or more uplink knowledge sharing messages after it receives a message from the network indicating that the uplink is congested. Furthermore, this portion of the knowledge sharing protocol may prohibit all uplink knowledge sharing messaging, while still indicating that downlink knowledge sharing messaging may occur. Alternatively, this indication may allow the UE to perform messaging which indicates planned transfers, but which disallows providing knowledge sharing inputs on network configuration such as inactivity timer and/or discontinuous reception (DRx). Conversely, this may allow the UE to provide inputs with respect to inactivity timer and/or DRx, but disallow inputs with respect to planned transfers. The network may then configure this downlink indication in order to optimize the network performance, while considering the overhead generated by this uplink knowledge sharing messaging, and the observed benefits generated by this knowledge sharing messaging. Furthermore, the network may disallow this messaging from a subset of the UE devices, for example where the benefit of such messaging is expected to be smaller, or where the UE devices which tend to generate less traffic, or where subscriber device's power preference indicator indicates that performance is more important than conserving power.

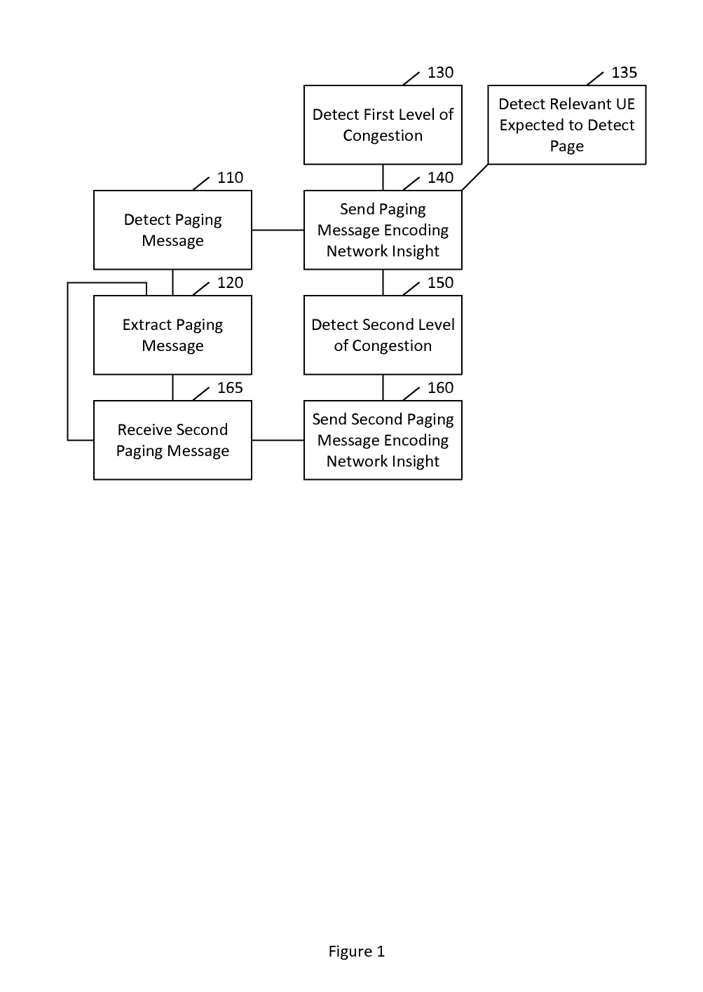

FIG. 1 illustrates a method according to certain embodiments. As shown in FIG. 1, a method can include, at 110, detecting, by a device, at least one paging message over a cellular system. The method can also include, at 120, extracting, from the at least one paging message, at least one cellular network insight comprising at least one cellular network condition.

An international mobile subscriber identity (IMSI) value can be used to convey that a cellular network insight is being provided.

The IMSI value used can be configured to additionally convey at least one of: uplink congestion, downlink congestion, or a randomization interval over which the user equipment should wait before performing access.

If the UE subsequently performs access, after being informed through this mechanism that there is a lack of congestion, then this access may not be a page response, and may not use the special reserved IMSI value which was paged.

The randomization interval mentioned may further avoid surges and congestion on the uplink resulting from lots of UEs simultaneously attempting to connect after detecting that the cell is uncongested.

The selection of the IMSI value can be further configured to convey which user equipment vendor category is being informed of the cellular network congestion information.

For example, it may be that devices from a particular manufacturer or using a particular operating system, do a better job of randomizing the back off before performing access after being informed of an un-congested event. In contrast if other devices, from another manufacturer or operating system, may perform access almost immediately after being informed of an un-congested event. In this context, in order to create fairness and load-balancing, it may be that the former devices are first informed of the un-congested event, and then subsequently using a different IMSI value the latter devices are informed of the un-congested event.

Furthermore, there may be a larger set of IMSI values that can be used to convey cellular networking events. For example, it may be that by using 32 different IMSI values, that five bits of network assistance data can be conveyed, where the choice of which of the 32 IMSI values is included in the page message, conveys a number between zero and 31.

In another embodiment, additional network assistance data can be conveyed by utilizing a page message which transmits multiple reserved IMSI values within the same page message. For example, if both the first and the second reserved IMSI values are included in a page message, then this may represent a 33^{rd} possible indication being conveyed by the reserved IMSI values. This approach would result in additional octets within a single page message. As a result, in one embodiment, the use of multiple reserved IMSI indications within a page message may be used to indicate conditions corresponding to at least one of the reduced congestion and reduced paging load, where this additional page message size is more likely acceptable.

Specific reserved IMSI values may correspond to specific paging occasions. However, in certain embodiments the reserved IMSI value(s) may be used in any ann all paging occasion, regardless of this correspondence. In another embodiments, different groups of IMSI values may be reserved such that there is a group of reserved IMSI values corresponding to each paging occasion. In this way the reserved IMSI values may be used which appropriately correspond to each specific paging occasion over which they are being delivered.

In other embodiments, the reserved IMSI values may be (preferably) limited to specific paging occasions. This enables the UE, when seeking to obtain network assistance data, to avoid monitoring certain paging occasions, which are not part of the group of specific paging occasions where reserved IMSI values may be transmitted. In a further embodiment, the system may rotate the set of specific paging occasions possibly used by the reserved IMSI values. The system may further rotate the delivery of IMSI across each periodic paging occasion. In this embodiment, the system may then avoid generating disproportionately large load on any one group of paging occasions. In another embodiment, the network may include the reserved IMSI value in additional paging occasions (beyond the limited group of specific paging occasions) when the network and/or paging messages less loaded/congested. In this way, a UE may be able to monitor only the paging occasions which it normally monitor for pages directed to it, and will not need to monitor any additional paging occasions to obtain the network assistance data. This may then enable the UE to save additional battery life.

In another embodiment a UE may determine the priority with which it needs to obtain network assistance data, and/or obtain this network assistance data rapidly. If it determines that this priority is relatively high, then the UE may monitor more/additional paging occasions, in order to enable it to more rapidly determine the most recent network assistance data information.

In another embodiment, the network may only include the reserved IMSI value if the paging message is already being transmitted, e.g. in order to deliver page notification to other UEs. For example, if no other UEs need to be paged during that paging occasion such that no paging message would normally be delivered, then the reserved IMSI value may not be included.

The network may use a specific encoding mechanism to determine which IMSI conveys which cellular networking event. This encoding mechanism can use information which is potentially commonly known both by the UE and the eNB, such as the cell ID, the system frame number, and the date and a preselected encryption mechanism/seed.

Such techniques may make it difficult for a third party or different UE vendor to then extract the cellular network assistance data, without the knowledge of this encoding/encryption mechanism.

The detecting can be performed by an application on the device. Moreover, the device may be a user equipment.

Extracting, at 120, the cellular networking insight can include at least one of extracting cellular system information from the paging message or verifying the paging message matches a predetermined value. The extracting and indeed the method handling such paging messages can omit replying to the page conveying the network assistance data.

The cellular network condition encoded in the at least one cellular network insight can be configured to convey that the condition corresponds to at least one specific cellular network access point and the condition can be configured to convey at least one of a cellular access point congestion condition or an expected cellular network throughput condition.

As mentioned above, the features at 110 and 120 can be performed by a user equipment. These aspects of the method illustrated in FIG. 1 may be responsive to actions undertaken by an access node, such as an evolved node B or the like.

Thus, for example, the method can include, at 130, detecting, at a device, a first level of network congestion on a cellular network. The method can also include, at 140, in response to the detecting of the first level of network congestion, transmitting a paging message. The paging message can include an international mobile subscriber identity (IMSI) value over the cellular network. The IMSI value can encode the first level of network congestion on the cellular network.

The transmitting can be further contingent on detecting, at 135, that at least one aware user equipment is known to be within a corresponding cell or tracking area, or is known to be checking the paging message at a corresponding discontinuous reception wake up/offset time. These and like conditions can be generally referred to detecting that a relevant user equipment is expected to detect the paging message.

The IMSI value can be created locally at the device based on local knowledge of congestion on the uplink and/or downlink. Thus, the value may not be generated at the MME, as would be previously typical.

No re-paging may be performed with respect to the paging message. Indeed, no UE access/page response may be expected nor accepted. Indeed, if any such attempt did result, then this can be logged as a special protocol failure event for follow-up.

The method can further include, at 150, detecting, by the device, a second level of network congestion on the cellular network. The method can additionally include, at 160, in response to the detecting of the second level of network congestion, transmitting a second IMSI value over the cellular network, wherein the second IMSI value encodes the second level of network congestion. This second IMSI value can be received by a user equipment at 165.

The detecting the first level can be performed by an access node. Likewise, the detecting the second level can also be performed by the access node. The access node can include at least one of an access point, a base station, or an evolved Node B.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
detecting, by a device, at least one paging message over a cellular system; and
extracting, from the at least one paging message, at least one cellular network insight comprising at least one cellular network condition.

2. The method of claim 1, wherein an international mobile subscriber identity (IMSI) value is used to convey that a cellular network insight is being provided.

3. The method of claim 2, wherein the IMSI value used is configured to additionally convey at least one of: uplink congestion, downlink congestion, or a randomization interval over which the user equipment should wait before performing access.

4. The method of claim 2, wherein the selection of the IMSI value, is further configured to convey which user equipment vendor category is being informed of the cellular network congestion information.

5. The method of claim 1, wherein the detecting is performed by an application on the device.

6. The method of claim 1, wherein the device comprises a user equipment.

7. The method of claim 1, wherein extracting the cellular networking insight comprises at least one of
extracting cellular system information from the paging message; or
verifying the paging message matches a predetermined value.

8. The method of claim 1, wherein the cellular network condition encoded in the at least one cellular network insight is configured to convey that the condition corresponds to at least one specific cellular network access point and wherein the condition is configured to convey at least one of a cellular access point congestion condition or an expected cellular network throughput condition.

9. A method, comprising:
detecting, at a device, a first level of network congestion on a cellular network; and
in response to the detecting of the first level of network congestion, transmitting a paging message, wherein the paging message comprises an international mobile subscriber identity (IMSI) value over the cellular network, wherein the IMSI value encodes the first level of network congestion on the cellular network.

10. The method of claim 9, wherein the transmitting is further contingent on detecting that at least one aware user equipment is known to be within a corresponding cell or tracking area, or is known to be checking the paging message at a corresponding discontinuous reception wake up/offset time.

11. The method of claim 9, wherein no re-paging is performed with respect to the paging message.

12. The method of claim 9, wherein the IMSI value is created locally at the device based on local knowledge of congestion on the uplink and/or downlink.

13. The method of claim 9, further comprising:
detecting, by the device, a second level of network congestion on the cellular network; and
in response to the detecting of the second level of network congestion, transmitting a second IMSI value over the cellular network, wherein the second IMSI value encodes the second level of network congestion.

14. The method of claim 9, wherein the detecting the first level is performed by an access node.

15. The method of claim 14, wherein the access node comprises at least one of an access point, a base station, or an evolved Node B.

16. An apparatus, comprising:
at least one processor; and
at least one memory including computer program code,
wherein the at least one memory and the computer program code are configured to, with the at least one processor, cause the apparatus at least to
detect, by a device, at least one paging message over a cellular system; and
extract, from the at least one paging message, at least one cellular network insight comprising at least one cellular network condition.

17. The apparatus of claim 16, wherein an international mobile subscriber identity (IMSI) value is used to convey that a cellular network insight is being provided.

18. The apparatus of claim 17, wherein the IMSI value used is configured to additionally convey at least one of: uplink congestion, downlink congestion, or a randomization interval over which the user equipment should wait before performing access.

19. The apparatus of claim 17, wherein the selection of the IMSI value, is further configured to convey which user equipment vendor category is being informed of the cellular network congestion information.

20. The apparatus of claim 16, wherein the detection is performed by an application on the device.

21. The apparatus of claim 16, wherein the device comprises a user equipment.

22. The apparatus of claim 16, wherein extraction of the cellular networking insight comprises at least one of
extracting cellular system information from the paging message; or
verifying the paging message matches a predetermined value.

23. The apparatus of claim 16, wherein the cellular network condition encoded in the at least one cellular network insight is configured to convey that the condition corresponds to at least one specific cellular network access point and wherein the condition is configured to convey at least one of a cellular access point congestion condition or an expected cellular network throughput condition.

24. An apparatus, comprising:
at least one processor; and
at least one memory including computer program code,
wherein the at least one memory and the computer program code are configured to, with the at least one processor, cause the apparatus at least to
detect, at a device, a first level of network congestion on a cellular network; and
in response to the detection of the first level of network congestion, transmit a paging message, wherein the paging message comprises an international mobile subscriber identity (IMSI) value over the cellular network, wherein the IMSI value encodes the first level of network congestion on the cellular network.

25. The apparatus of claim 24, wherein the transmission is further contingent on detecting that at least one aware user equipment is known to be within a corresponding cell or tracking area, or is known to be checking the paging message at a corresponding discontinuous reception wake up/offset time.

26. The apparatus of claim 24, wherein the at least one memory and the computer program code are configured to, with the at least one processor, cause the apparatus at least to omit re-paging with respect to the paging message.

27. The apparatus of claim 24, wherein the IMSI value is created locally at the device based on local knowledge of congestion on the uplink and/or downlink.

28. The apparatus of claim 24, wherein the at least one memory and the computer program code are configured to, with the at least one processor, cause the apparatus at least to:
detect, by the device, a second level of network congestion on the cellular network; and
in response to the detection of the second level of network congestion, transmit a second IMSI value over the cellular network, wherein the second IMSI value encodes the second level of network congestion.

29. The apparatus of claim 24, wherein the detection of the first level is performed by an access node.

30. The apparatus of claim 29, wherein the access node comprises at least one of an access point, a base station, or an evolved Node B.
